(19) United States
(12) Patent Application Publication
(10) Pub. No.: US 2012/0115048 A1
(43) Pub. Date: May 10, 2012

(54) POSITIVE ELECTRODE FOR LITHIUM AIR BATTERY, METHOD OF PREPARING THE POSITIVE ELECTRODE, AND LITHIUM AIR BATTERY INCLUDING THE POSITIVE ELECTRODE

(75) Inventors: Victor Roev, Suwon-si (KR); Young-gyoon Ryu, Suwon-si (KR); Dong-min Im, Seoul (KR); Dong-joon Lee, Seoul (KR); Jeong-kuk Sohn, Cheonan-si (KR); Sang-bok Ma, Yongin-si (KR); Min-sik Park, Suwon-si (KR)

(73) Assignee: Samsung Electronics Co., Ltd., Suwon-si (KR)

(21) Appl. No.: 13/181,005

(22) Filed: Jul. 12, 2011

(30) Foreign Application Priority Data
Nov. 4, 2010 (KR) 10-2010-0109261

(51) Int. Cl. H01M 8/22; B01J 21/18; H01M 8/02; B82Y 30/00

(52) U.S. Cl. 429/405; 502/1; 977/773

(57) ABSTRACT

A positive electrode for a lithium air battery, the positive electrode including a carbonaceous material doped with a non-metallic element.

### CROSS-REFERENCE TO RELATED APPLICATION

This application claims the benefit of Korean Patent Application No. 10-2010-0109261, filed on Nov. 4, 2010 in the Korean Intellectual Property Office, the disclosure of which is incorporated herein in its entirety by reference.

### BACKGROUND

1. Field

Aspects of the present disclosure relate to positive electrodes for a lithium air battery, methods of preparing the positive electrodes, and lithium air batteries including the positive electrodes, and more particularly, to positive electrodes that include a catalyst and/or a catalyst support and are used in a lithium air battery, methods of preparing the positive electrodes, and high energy efficient lithium air batteries including the positive electrodes.

2. Description of the Related Art

It is known that a lithium air battery includes a negative electrode enabling intercalation/deintercalation of lithium ions, a positive electrode including a catalyst for catalyzing oxidation and reduction of oxygen in air, and a lithium ion-conducting medium between the positive electrode and the negative electrode, in which the oxygen is used as a positive electrode active material.

Lithium air batteries have a theoretical energy density of 3,000 Wh/kg or more, which is about 10 times greater than that of a lithium ion battery. Lithium air batteries are environmentally friendly, and more stable than a lithium ion battery. Due to such characteristics, research into lithium air batteries is being actively conducted.

Lithium air batteries have a theoretical capacitance of a few thousand mAh/g, and if a positive electrode for a lithium air battery includes an appropriate catalyst, performance of the lithium air battery may be improved. For example, an organometallic complex such as phthalocyanine, a precious metal such as platinum (Pt), or an oxide catalyst such as Co₃O₄, or a manganese oxide may be used with a carbonaceous material. However, such methods lead to complicated and expensive manufacturing processes.

### SUMMARY

Aspects of the present invention provide positive electrodes for a lithium air battery that include a catalyst and/or a catalyst support.

Aspects of the present invention provide methods of preparing the positive electrodes for a lithium air battery.

Aspects of the present invention provide high energy efficient lithium air batteries including the positive electrodes.

According to an aspect of the present invention, a positive electrode for a lithium air battery includes a carbonaceous material doped with a non-metallic element.

The average particle diameter of the carbonaceous material doped with the non-metallic element is in a range of about 2 nm to about 900 nm.

The non-metallic element may include at least one element selected from the group consisting of Group 13 through 16 elements.

The non-metallic element may include at least one element selected from the group consisting of nitrogen (N), sulfur (S), phosphorus (P), selenium (Se), tellurium (Te), and boron (B).

The carbonaceous material doped with the non-metallic element is a catalyst having conductivity, and the catalyst promotes an oxygen reduction reaction and an oxygen evolution reaction.

The carbonaceous material doped with the non-metallic element may further include an oxygen reduction catalyst and an oxygen evolution catalyst.

The amount of the non-metallic element used to dope the carbonaceous material is in a range of about 0.1 to about 30 parts by weight based on 100 parts by weight of the carbonaceous material.

The carbonaceous material doped with the non-metallic element may further include a transition metal.

The carbonaceous material doped with the non-metallic element may further include a transition metal oxide selected from the group consisting of a manganese oxide, a cobalt oxide, an iron oxide, a zinc oxide, and a nickel oxide.

The carbonaceous material may include one material selected from the group consisting of carbon black, graphite, graphene, activated carbon, and carbon fiber.

According to another aspect of the present invention, a method of preparing a positive electrode for a lithium air battery includes: (a) mixing a non-metal precursor and a mesoporous material with a solvent to prepare a slurry; (b) drying the slurry and calcining the dried product under an inert atmosphere to produce a calcined product; and (c) contacting the calcined product with a hydrogen halide.

The non-metal precursor in operation (a) may include at least one compound selected from the group consisting of quinoxaline, hemin, and p-toluene sulfonic acid, cobalt-tetramethoxy-phenylporphyrin, iron-tetramethoxy-phenyl porphyrin, phthalocyanine, cobalt-phthalocyanine, and iron-phthalocyanine.

The slurry in operation (a) may further include a transition metal precursor.

The transition metal precursor may include at least one compound selected from the group consisting of Fe(NO₃)₂, Fe(NO₃)₃, Fe(CH₃COO)₂ and Fe(CH₃COO)₃.

According to another aspect of the present invention, a lithium air battery includes: a negative electrode enabling intercalation and deintercalation of lithium ions; an electrolyte; and a positive electrode using oxygen as a positive electrode active material, wherein the positive electrode includes a carbonaceous material doped with a non-metallic element.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a schematic view of a lithium air battery according to an embodiment of the present invention;

FIG. 2 is a graph showing catalytic effects with respect to a discharge overvoltage during discharging, measured according to Evaluation Example 1; and

FIG. 3 is a graph showing catalytic effects with respect to a charge overvoltage during charging, measured according to Evaluation Example 1.

### DETAILED DESCRIPTION

Reference will now be made in detail to the present embodiments of the present invention, examples of which are illustrated in the accompanying drawings, wherein like reference numerals refer to like elements throughout. The embodiments are described below in order to explain the present invention by referring to the figures.

Hereinafter, lithium air batteries according to embodiments of the present invention will be described in detail. However, the embodiments are provided for illustrative purposes only, and the present invention will be defined only by claims later.

A positive electrode for a lithium air battery according to an embodiment of the present invention includes a carbonaceous material doped with a non-metallic element.

A lithium air battery includes a positive electrode that uses oxygen in air as an active material, and is charged and discharged according to oxidation and reduction of oxygen at the positive electrode.

A lithium air battery includes an electrolyte, for example, an aqueous electrolyte or a non-aqueous electrolyte, and when a lithium air battery includes a non-aqueous electrolyte as an electrolyte, a reaction mechanism represented by Reaction Scheme 1 below may occur:

4Li+O₂ [symbol] 2Li₂O E^{o}=2.91V

2Li+O₂ [symbol] Li₂O₂ E^{o}=3.10V. <Reaction Scheme 1>

That is, during discharging, lithium generated from a negative electrode reacts with oxygen at the positive electrode to generate a lithium oxide, thereby reducing oxygen (oxygen reduction reaction: ORR). Also, during charging, the lithium oxide is reduced and oxygen is oxidized and evolved (oxygen evolution reaction: OER).

In this case, the actual discharge/charge voltage is smaller than the theoretical discharge/charge voltage since an overvoltage occurs due to energy used to reduce/evolve oxygen and, thus, energy efficiency of a lithium air battery is lowered.

For example, if a positive electrode includes only a porous carbonaceous material and does not include a catalyst, energy efficiency of the lithium air battery is as low as 57% of theoretical due to a discharge overvoltage (η_{dis}) and a charge overvoltage (η_{chg}).

However, if the positive electrode further includes a catalyst, supply of oxygen during discharging and generating of oxygen during charging may be promoted, thereby lowering the discharge overvoltage (η_{dis}) and the charge overvoltage (η_{chg}) and increasing the energy efficiency of the lithium air battery to 60% or more.

However, if the catalyst is, for example, a precious metal, such as Pt or Au, or a heat-treated Co phthalocyanine, the manufacturing process is complicated and expensive. Accordingly, a catalyst that is less expensive and makes the manufacturing process less complicated than when using a precious metal catalyst or an organometallic complex catalyst and has the same catalytic activity as the precious metal catalyst and the organometallic complex catalyst is needed.

The carbonaceous material doped with the non-metallic element may be used as a catalyst and/or catalyst support in the positive electrode.

Mass activity (J) of a catalyst represents catalytic activity and is represented by Reaction Scheme 2 below:

J(A/g)=S(cm²/g)×Iₖ(A/cm²) <Reaction Scheme 2>

That is, as the specific surface area (S) and the current density (Iₖ) increase, the catalyst mass activity (J) increases.

In detail, the specific surface area depends on the particle size of a carbonaceous material and the current density depends on an element used to dope the carbonaceous material. That is, if the particle size of the carbonaceous material is nano-scale, the specific surface area increases, and if the element used to dope the carbonaceous material is a non-metallic element, the current density increases, thereby increasing the catalyst mass activity.

For example, the average particle diameter of the carbonaceous material doped with the non-metallic element may be in a range of about 2 nm to 900 nm, for example, about 2 nm to about 30 nm. The carbonaceous material doped with the non-metallic element may include one material selected from the group consisting of carbon black, graphite, graphene, activated carbon, and carbon fiber, each of which has a nano-scale average particle size. For example, the carbonaceous material doped with the non-metallic element may include a carbon nano particle, a mesoporous carbon, a carbon nano tube, a carbon nano fiber, a carbon nano sheet, or a carbon nano rod, each of which has a nano-scale average particle size, but the present invention is not limited thereto.

Also, the specific surface area of the carbonaceous material doped with the non-metallic element may be measured by performing BET analysis and the analysis value of the specific surface area may be 10 m²/g or more, for example, 50 m²/g or more, or for example, 100 m²/g or more.

If the average particle size and the specific surface area of the carbonaceous material doped with the non-metallic element are within the ranges described above, when the carbonaceous material doped with the non-metallic element is used as a catalyst and/or catalyst support, the contact area with oxygen increases and the charge and discharge capacity of a lithium air battery including the catalyst and/or catalyst support increases, thereby enabling the manufacture of a high capacity lithium air battery.

The amount of the carbonaceous material doped with the non-metallic element may be in a range of about 65 parts by weight to about 99 parts by weight, for example, about 75 parts by weight to about 95 parts by weight, based on 100 parts by weight of the positive electrode using oxygen as an active material.

If the amount of the carbonaceous material doped with the non-metallic element is within the range described above, the catalyst and/or catalyst support including the carbonaceous material doped with the non-metallic element has a sufficient catalytic effect and a lithium air battery including the catalyst and/or catalyst support retains its capacity.

The non-metallic element may include at least one element selected from the group consisting of Groups 13 through 16 elements. For example, the non-metallic element may include at least one element selected from the group consisting of N, S, P, Se, Te, and B. For example, the non-metallic element includes N, S, or N and S.

The non-metallic element may be any non-metallic element that is easily introduced into a carbonaceous structure, and an organic precursor having the non-metallic element is commercially available.

In addition, the catalyst and/or catalyst support including the carbonaceous material doped with the non-metallic element enables charging at low voltage during charging and enables discharging at high voltage during discharging. Accordingly, a lithium air battery having high energy efficiency may be manufactured without using a complicated process or expensive material.

That is, the carbonaceous material doped with the non-metallic element is used as a catalyst having conductivity and the catalyst may promote the ORR and the OER.

In general, a catalyst may be any one of an oxygen reduction catalyst for the ORR or an oxygen evolution catalyst for the OER. Thus, in order to have the two functions, the oxygen reduction catalyst and the oxygen evolution catalyst are used in combination. For example, an oxygen reduction catalyst may lower the discharge overvoltage (η_{dis}) during discharging, and the oxygen evolution catalyst may lower a charge overvoltage (η_{chg}) during charging. Thus, in order to increase the energy efficiency of a lithium air battery, the oxygen reduction catalyst and the oxygen evolution catalyst need to be used in combination.

However, the oxygen evolution catalyst slowly increases the rate of the OER and thus, a long charge time is required. However, fast charging is necessary when using power electronic devices. Accordingly, a catalyst material that has conductivity and promotes the ORR and the OER is needed.

If the carbonaceous material doped with a non-metallic element is used as a catalyst, without using the oxygen reduction catalyst and the oxygen evolution catalyst in combination, the catalyst alone may substantially increase rates of the ORR and the OER, and thus, a lithium air battery including a positive electrode including the catalyst has high energy efficiency.

Also, the carbonaceous material doped with a non-metallic element may further include an oxygen reduction catalyst and an oxygen evolution catalyst. Examples of an oxygen reduction catalyst include silver, platinum, platinum-ruthenium, spinel, perovskite, iron, nickel, cobalt mega-ring, a metal hydroxide, and a manganese compound. Examples of an oxygen evolution catalyst include WC, WC-fused cobalt, CoWO₄, FeWO₄, NiS, and WS₂.

The amount of the non-metallic element used to dope the carbonaceous material may be in a range of about 0.1 to about 30 parts by weight based on 100 parts by weight of the carbonaceous material. If the amount of the non-metallic element is within the range described above, when the carbonaceous material doped with the non-metallic element is used as a catalyst and/or catalyst support, the catalyst and/or catalyst support has conductivity and sufficient current density and high catalytic activity.

The carbonaceous material doped with the non-metallic element may further include a transition metal.

For example, the carbonaceous material doped with the non-metallic element may further include at least one transition metal selected from the group consisting of Co, Ni, Fe, Au, Ag, Pt, Ru, Rh, Os, Ir, and Pd.

The carbonaceous material doped with the non-metallic element may further include a transition metal oxide, such as a manganese oxide, a cobalt oxide, an iron oxide, a zinc oxide, or a nickel oxide. For example, the carbonaceous material doped with the non-metallic element may further include an organometallic catalyst such as a cobalt phthalocyanine. Also, the carbonaceous material doped with the non-metallic element may further include Li₂O or Ag₂O, but is not limited thereto.

A method of preparing a positive electrode for a lithium air battery according to an embodiment of the present invention includes: (a) mixing a non-metal precursor and a mesoporous material with a solvent to prepare a slurry; (b) drying the slurry and calcining the dried product under an inert atmosphere to produce a calcined product; and (c) bringing the calcined product into contact with a hydrogen halide.

In the method, the mesoporous material is used as a template and the non-metal precursor is attached to the surface of the mesoporous material and then coating, drying, and carbonating are performed thereon. Then, the resultant product is brought into contact with a hydrogen halide to remove an iron component, and then dried.

In detail, a slurry is prepared by mixing a non-metal precursor and a mesoporous material with a solvent in operation (a).

The non-metal precursor in operation (a) may include at least one compound selected from the group consisting of quinoxaline, hemin, p-toluene sulfonic acid, cobalt-tetramethoxy-phenylporphyrin, iron-tetramethoxy-phenylporphyrin, phthalocyanine, cobalt-phthalocyanine, and iron-phthalocyanine.

The mesoporous material may be used as a template, and may include mesoporous silica. Mesoporous silica is a nano material having a uniformly structured arrangement of nano channels. For example, the mesoporous silica may include MCM-48 (Mobil Composition of Matter No. 48), KIT-1 (Korea Advanced Institute of Science and Technology No. 1), MSU-1 (Michigan State University No. 1), SBA-1 (Santa Barbara Amorphous No. 1), SBA-16 (Santa Barbara Amorphous No. 16), SBA-15 (Santa Barbara Amorphous No. 15), SBA-3 (Santa Barbara Amorphous No. 3), MCM-41, KIT-6, and a mixture thereof. However, the mesoporous silica is not limited thereto.

The pore diameter of the mesoporous silica may be in a range of about 2 to about 50 nm; for example, about 2 to about 40 nm; or for example, about 2 to about 30 nm, but is not limited thereto.

The slurry in operation (a) may further include a transition metal precursor. An iron element is known to improve crystallinity and structural stability of carbon when carbon is formed. For example, the transition metal precursor may include at least one compound selected from the group consisting of Fe(NO₃)₂, Fe(NO₃)₃, Fe(CH₃COO)₂, and Fe(CH₃COO)₃.

The solvent may include at least one solvent selected from the group consisting of acetone, water, alcohol, and tetrahydrofuran.

The slurry in operation (a) may be prepared by immersion, chemical vapor deposition (CVD), or physical vapor deposition (PVD). However, the preparation method is not limited thereto and any commercially available method may be used herein.

The slurry is dried and calcined in an inert atmosphere to produce a calcined product in operation (b). For example, the slurry may be dried at room temperature for 12 hours and, then, calcined in an inert atmosphere for about 1 hour to about 4 hours at a temperature of about 600 to about 1000° C., for example, for about 2 to about 3 hours at a temperature of about 700 to about 900° C., or for example, for 2 hours at a temperature of 900° C., to produce a calcined product.

The calcined product is brought into contact with a hydrogen halide so as to remove any iron component. Examples of the hydrogen halide include about 10 to 30% HF, HCl, HBr, or Hl. For example, the hydrogen halide may be about 20% HF.

Then, the method may further include drying. The drying may include heat treating at a temperature of about 100 to about 120° C. under vacuum.

The method described above is simple and requires relatively inexpensive reaction materials.

A lithium air battery according to an embodiment of the present invention includes a negative electrode enabling intercalation and deintercalation of lithium ions; an electrolyte; and a positive electrode using oxygen as a positive electrode active material, in which the positive electrode includes a carbonaceous material doped with a non-metallic element.

The carbonaceous material doped with the non-metallic element is the same as described above.

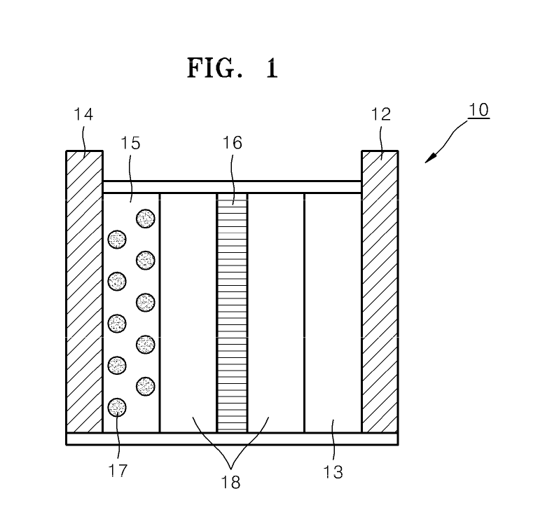

FIG. 1 is a schematic view of a lithium air battery 10 according to an embodiment of the present invention. Referring to FIG. 1, the lithium air battery 10 includes a first current collector 12, a negative electrode 13 that enables intercalation and deintercalation of lithium ions and is adjacent to the first current collector 12, a positive electrode 15 using as an active material oxygen generated at a second current collector 14, and an electrolyte 18 interposed between the negative electrode 13 and the positive electrode 15, in which the positive electrode 15 includes a catalyst 17. Also, a lithium ion-conducting solid electrolyte membrane 16 may be interposed between the negative electrode 13 and the positive electrode 15, and a separator (not shown) may be disposed between the lithium ion-conducting solid electrolyte membrane 16 and the positive electrode 15.

The first current collector 12 may be porous and may act as a gas diffusion layer through which air diffuses. The first current collector 12 may be formed of any one of various conductive materials. For example, the first current collector 12 may be formed of copper, stainless steel, or nickel. The shape of the first current collector 12 may be, for example, a thin film-shape, a panel-shape, a mesh-shape, or a grid-shape.

The negative electrode 13 enabling intercalation and deintercalation of lithium ions may be formed of lithium metal, a lithium metal-based alloy, or a lithium intercalating compound. An example of the lithium metal-based alloy may be an alloy of lithium with one or more of aluminum, tin, magnesium, indium, calcium, titanium, and vanadium. An example of the lithium intercalating compound is a carbonaceous material such as graphite. The negative electrode 13 enabling intercalation and deintercalation of lithium ions may include lithium metal and a carbonaceous material. For example, in consideration of high capacity characteristics, the negative electrode 13 enabling intercalation and deintercalation of lithium ions may include lithium metal.

The negative electrode 13 enabling intercalation and deintercalation of lithium ions may include a binder. Examples of a binder for use in the negative electrode 13 include polyvinylidene fluoride (PVdF) and polytetrafluoro ethylene (PTFE). The amount of binder used is not limited. For example, the amount of binder may be 30 weight % or less, for example, in a range of about 1 to about 10 weight % based on the total amount of the negative electrode.

The second current collector 14 may be formed of any one of various conductive materials. For example, the second current collector 14 may be formed of stainless steel, nickel, aluminum, iron, titanium, or carbon. The shape of the second current collector 14 may be, for example, a thin film-shape, a panel-shape, a mesh-shape, or a grid-shape. For example, the second current collector 14 may have a mesh-shape. A current collector having a mesh-shape has excellent current collecting efficiency and, thus, is suitable for a lithium air battery.

Besides the catalyst 17, the positive electrode 15 using oxygen as an active material may further include other catalysts, such as WC, WC-fused cobalt, CoWO₄, FeWO₄, NiS, WS₂, Ag, perovskite, or spinel. The spinel refers to an oxide represented by AB₂O₄ where A is a bivalent metallic ion including at least one element selected from the group consisting of magnesium, iron, nickel, manganese, and zinc and B is a trivalent metal ion including at least one element selected from the group consisting of aluminum, iron, chromium, and manganese. The perovskite refers to an oxide represented by AXO₃ where A is a bivalent metallic ion including at least one element selected from the group consisting of cerium, calcium, sodium, strontium, lead, and various rare-earth metals and X is a tetrahedral metal including at least one element selected from the group consisting of titanium, niobium, and iron. All the group elements may have the same basic structure as XO₃ having a mutually connected octahedral structure.

The positive electrode 15 using oxygen as an active material may further include a binder. The type and amount of binder used are the same as described in connection with the negative electrode, and thus, will not be described in detail here.

The electrolyte 18 may be an aqueous electrolyte or a non-aqueous electrolyte. An example of a non-aqueous electrolyte is an organic solvent that does not include water. Examples of a non-aqueous electrolyte include a carbonate-based solvent, an ester-based solvent, an ether-based solvent, a ketone-based solvent, an organosulfur-based solvent, an organophosphorus-based solvent, and a non-protonic solvent.

Examples of a carbonate-based solvent include dimethyl carbonate (DMC), diethyl carbonate (DEC), ethyl methyl carbonate (EMC, methyl ethyl carbonate or MEC), dipropyl carbonate (DPC), methyl propyl carbonate (MPC), ethyl propyl carbonate (EPC, ethylene carbonate (EC), propylene carbonate (PC), fluoroethylene carbonate (FEC), and butylene carbonate (BC). Examples of an ester-based solvent include methyl acetate, ethyl acetate, n-propyl acetate, 1,1-dimethyl ethyl acetate, methyl propionate, ethyl propionate, y-butyrolactone, 5-decanolide, y-valerolactone, dl-mevalonolactone, and y-caprolactone. Examples of an ether-based solvent include dibutyl ether, tetraglyme, diglyme, dimethoxyethane, 2-methyl tetrahydrofuran, and tetrahydrofuran. Examples of a ketone-based solvent include cyclohexanone. An example of an organosulfur-based solvent includes methanesulfonyl chloride and an example of an organophosphorus-based solvent includes P-trichloro-N-dichloro phosphoryl monophosphazene. Examples of a non-protonic solvent include nitriles represented by R-CN (where R is a linear, branched, or cyclic hydrocarbonyl group having 2 to 20 carbons, and R may have a cyclic or ether bond toward a double bond), amides such as dimethyl formamide, dioxolanes such as 1,3-dioxolane, and sulfolanes.

The non-aqueous organic solvents may be used alone or in combination. If the non-aqueous organic solvents are used in combination, the mixture ratio may be appropriately controlled according to the performance requirements of the battery to be manufactured and may be known to one of ordinary skill in the art.

The non-aqueous organic solvent may include a lithium salt. The lithium salt may be dissolved in an organic solvent and acts as a supplier for lithium ions in the lithium air battery 10. For example, the non-aqueous organic solvent may promote migration of lithium ions between the negative electrode 13 and the lithium ion-conducting solid electrolyte membrane 16. The lithium salt includes at least one salt selected from the group consisting of LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂) where x and y are natural numbers, LiF, LiBr, LiCl, Lil, and lithium bis(oxalato) borate [LiB(C₂O₄)₂] (LiBOB). The concentration of the lithium salt may be in a range of about 0.1 to about 2.0 M. If the concentration of the lithium salt is within the range described above, an electrolyte including the lithium salt may have appropriate conductivity and viscosity and, thus, may have excellent electrolyte performances and may allow lithium ions to effectively migrate. Besides the lithium salt, the non-aqueous organic solvent may further include other metal salts, such as AlCl₃, MgCl₂, NaCl, KCl, NaBr, KBr, or CaCl₂.

Also, the lithium ion-conducting solid electrolyte membrane 16 may be disposed between the negative electrode 13 and the positive electrode 15. The lithium ion-conducting solid electrolyte membrane 16 may act as a protection layer for preventing water contained in the electrolyte 18 from directly reacting with lithium contained in the negative electrode 13. The lithium ion-conducting solid electrolyte membrane 16 may include a lithium ion-conducting glass, a lithium ion-conducting crystal (ceramic or glass-ceramic), or a mixture thereof. In consideration of chemical stability, the lithium ion-conducting solid electrolyte membrane 16 may be an oxide.

Examples of a lithium ion-conducting crystal include Li_{1+x+y}(Al, Ga)ₓ(Ti, Ge)₂₋ₓSi_{y}P_{3-y}O₁₂ where 0≦x≦1 and 0≦y≦1, for example, 0≦x≦0.4 and 0≦y≦0.6, and for example, 0.1≦x≦0.3 and 0.1≦y≦0.4. Examples of a lithium ion-conducting glass-ceramic include lithium-aluminum-germanium-phosphate (LAGP), lithium-aluminum-titanium- phosphate (LATP), and lithium-aluminum-titanium-silicate-phosphate (LATSP). When the lithium ion-conducting solid electrolyte membrane 16 includes a lithium ion-conducting glass-ceramic, the lithium ion-conducting solid electrolyte membrane may further include a polymer solid electrolyte which is a polyethylene oxide doped with a lithium salt, such as, LiN(SO₂CF₂CF₃)₂, LiBF₄, LiPF₆, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, or LiAlCl₄.

The separator (not shown) may be disposed between the lithium ion-conducting solid electrolyte membrane 16 and the positive electrode 15. The separator may not be limited as long as it has high endurance during lithium air battery operation. The separator may include a polymer non-fabric, such as a polypropylene non-fabric or a polyphenylene sulfide non-fabric, or a porous film formed of an olefin-based resin, such as polyethylene or polypropylene. The separator materials may be used in combination.

The term “air” used herein is not limited to the atmospheric air, and refers to either a gas combination including oxygen or pure oxygen gas. The broad definition of the term “air” may be applied to all kinds of appliances including an air battery, an air positive electrode.

The lithium air battery may be a primary lithium battery or a secondary lithium battery. Also, the shape of the lithium air battery is not limited. For example, the positive electrode may have a coin-shape, a button-shape, a sheet-shape, a stack-shape, a cylinder-shape, a panel-shape, or a corn-shape. Also, the lithium air battery may be used in a large-size battery for use in electrical vehicles.

One or more embodiments will now be described in further detail with reference to the following examples. These examples are for illustrative purposes only and are not intended to limit the scope of the one or more embodiments.

### EXAMPLE

### Preparation of Positive Electrode Catalyst

### Preparation Example 1

### N Element-Doped Carbonaceous Material

1 g of Fe (NO₃)₃, 3 g of quinoxaline, and 5 g of mesoporous silica template (OMS) were mixed in 4.25 g of acetone and the mixture was agitated. Then, the mixture was dried at a temperature of 100° C. for 6 hours and then dried at a temperature of 160° C. for 6 hours to remove the solvent. Then, heat treatment was performed thereon in a N₂ gas atmosphere at a temperature of 900° C. for 3 hours. Then, the product was immersed in 20% HF for 4 hours and dried in air for 12 hours, thereby producing an N element-doped mesoporous carbon having an average particle size of 300 nm.

### Preparation Example 2

### N Element-Doped Carbonaceous Material

0.5 g of hemin and 7 g mesoporous silica template (OMS) were mixed in 15 mL of water and the mixture was agitated. Then, the mixture was dried at room temperature for 12 hours to remove the solvent and then heat treated in a N₂ gas atmosphere at a temperature of 850° C. for 3 hours. Then, the product was immersed in 50% HF for 4 hours and dried in air for 12 hours, thereby producing N element-doped carbon nanoparticles having an average particle size of 10 nm.

### Preparation Example 3

### S Element-Doped Carbonaceous Material

An S element-doped mesoporous carbon was prepared in the same manner as in Preparation Example 1, except that 4.25 g of p-toluene sulfonic acid was used instead of quinoxaline.

### Preparation Example 4

### N and S Element-Doped Carbonaceous Material

N and S element-doped mesoporous carbon was prepared in the same manner as in Preparation Example 1, except that 2.1 g of p-toluene sulfonic acid was further used.

### Manufacturing Lithium Air Battery

### Example 1

### Lithium Air Battery Including N Element-Doped Carbonaceous Material as Catalyst

A positive electrode including the N element-doped mesoporous carbon prepared according to Preparation Example 1 as a catalyst was prepared and mixed with 20% PVdF in NMP, coated on GDL-35AA (SGL Technologies GmbH) by a doctor-blade method and finally dried under vacuum. A lithium metal thin film was used as a negative electrode. Polypropylene (product of Celgard Inc.; 3501) was used to form a separator on the positive electrode.

The lithium metal thin film as the negative electrode was installed in a stainless case and a separator into which 1 M LiClO₄was injected was disposed facing the negative electrode. Then, the positive electrode was disposed on the separator in the opposite direction of the negative electrode. Then, a stainless steel mesh was disposed on the positive electrode and a push element was pressed on the stainless steel mesh to fix a cell so that airflow was toward the positive electrode, thereby completing manufacture of a lithium air battery.

The stainless case included an upper portion contacting the negative electrode and a lower portion contacting the positive electrode, and an insulating resin was interposed between the upper portion and the lower portion and electrically insulated the positive electrode from the negative electrode.

### Example 2

### Lithium Air Battery Including N Element-Doped Carbonaceous Material as Catalyst

A lithium air battery was manufactured in the same manner as in Example 1, except that the N element-doped carbon nanoparticle prepared according to Preparation Example 2 was used instead of the N element-doped mesoporous carbon prepared according to Preparation Example 1.

### Example 3

### Lithium Air Battery Including S Element-Doped Carbonaceous Material as Catalyst

A lithium air battery was manufactured in the same manner as in Example 1, except that the S element-doped mesoporous carbon prepared according to Preparation Example 3 was used instead of the N element-doped mesoporous carbon prepared according to Preparation Example 1.

### Example 4

### Lithium Air Battery Including N and S Element-Doped Carbonaceous Material as Catalyst

A lithium air battery was manufactured in the same manner as in Example 1, except that the N and S element-doped mesoporous carbon prepared according to Preparation Example 4 was used instead of the N element-doped mesoporous carbon prepared according to Preparation Example 1.

### Comparative Example 1

### Lithium Air Battery Including Carbonaceous Material that is not Doped with Non-Metallic Element

A lithium air battery was manufactured in the same manner as in Example 1, except that Ketjen Black 600D (KB600JD) was used instead of the N element-doped mesoporous carbon prepared according to Preparation Example 1.

### Comparative Example 2

### Lithium Air Battery Including Carbonaceous Material that is not Doped with Non-Metallic Element

A lithium air battery was manufactured in the same manner as in Example 1, except that Super P (product of 3M Inc.) was used instead of the N element-doped mesoporous carbon prepared according to Preparation Example 1.

### Comparative Example 3

### Lithium Air Battery Including Carbonaceous Material that is not Doped with Non-Metallic Element

A mesoporous carbon was prepared in the same manner as in Preparation Example 1, except that sucrose or phenanthrene was used instead of quinoxaline. Then, the same experiment as Example 1 was performed to manufacture a lithium air battery.

### Evaluation Example 1

The lithium air batteries manufactured according to Examples 1 to 4 and Comparative Examples 1 to 3 were discharged with a constant current of 0.2 mA/cm² at a temperature of 25° C. and at 1 atm until voltage reached 2 V (vs. Li), and then charged with the same current until a voltage is in a range of about 4.3 V to about 4.8 V. The charge and discharge test results are shown in Table 1 below and FIG. 4. A round-trip efficiency during charging and discharging is measured by Equation 1 below:

Round-trip efficiency (%)=(average discharge voltage/average charge voltage in fifth cycle)×100 <Equation 1>

The average charge voltage and the average discharge voltage correspond to voltages at half the total discharge and charge time period, respectively.

TABLE 1

| | Average charge | Average discharge | Round-trip |
|---|---|---|---|
| | voltage(V) | voltage(V) | efficiency (%) |
| Example 1 | 3.96 | 2.74 | 69 |
| Example 2 | 4.00 | 2.62 | 66 |
| Example 3 | 4.34 | 2.58 | 60 |
| Example 4 | 4.08 | 2.60 | 64 |
| Comparative | 4.48 | 2.55 | 57 |
| Example 1 | | | |
| Comparative | 4.56 | 2.44 | 54 |
| Example 2 | | | |
| Comparative | 4.39 | 2.55 | 58 |
| Example 3 | | | |

From the results shown in Table 1, it is confirmed that round-trip efficiencies (%) of the positive electrodes used in Examples 1 to 4 including as a catalyst a carbonaceous material doped with a non-metallic element are higher than those of the positive electrodes used in Comparative Examples 1 to 3 including as a catalyst a carbonaceous material that was not doped with a non-metallic element.

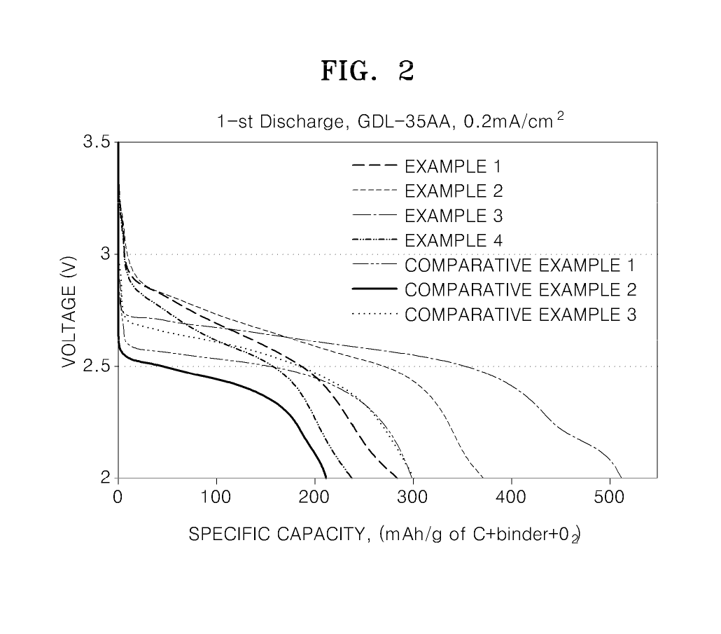

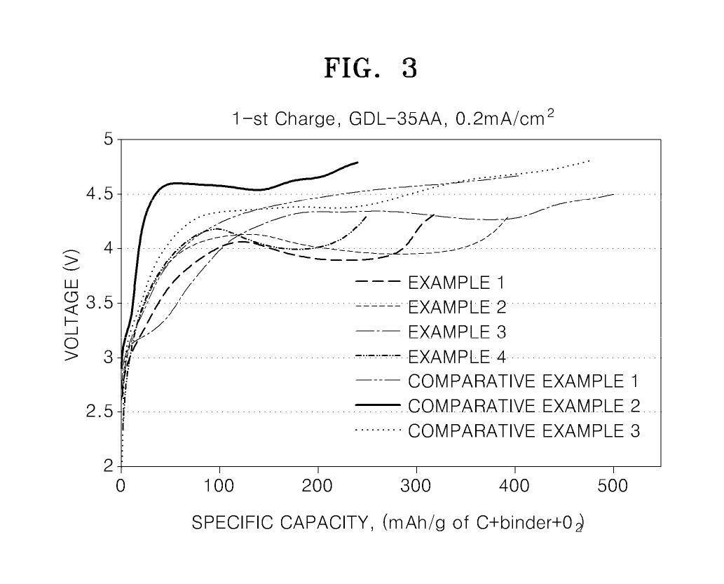

FIG. 2 is a graph showing catalytic effects with respect to discharge overvoltage during discharging measured according to Evaluation Example 1, and FIG. 3 is a graph showing catalytic effects with respect to charge overvoltage during charging measured according to Evaluation Example 1.

Referring to FIGS. 2 and 3, the discharge overvoltage (η_{dis}) and the charge overvoltage (η_{chg}) of the lithium air batteries of Examples 1 through 3 including an N, S, or N and S-doped carbonaceous material as a catalyst are about 0.28 V and about 0.3 V lower than those of the lithium air batteries of Comparative Examples 1 through 3, respectively.

The higher energy efficiency of the lithium air batteries of Examples 1 to 4 may be due to a catalytic effect of the N, S, or N and S element-doped carbonaceous material on an ORR and an OER as illustrated in FIGS. 2 and 3.

As described above, according to the one or more of the above embodiments of the present invention, since a lithium air battery includes a positive electrode including a carbonaceous material doped with a non-metallic element as a catalyst and/or catalyst support, the lithium air battery has high catalytic activity, and overvoltage is suppressed during charging and discharging and thus energy efficiency of the lithium air battery may be improved.

It should be understood that the exemplary embodiments described herein should be considered in a descriptive sense only and not for purposes of limitation. Descriptions of features or aspects within each embodiment should typically be considered as available for other similar features or aspects in other embodiments.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A positive electrode for a lithium air battery, the positive electrode comprising a carbonaceous material doped with a non-metallic element.

2. The positive electrode of claim 1, wherein an average particle diameter of the carbonaceous material doped with the non-metallic element is in a range of about 2 nm to about 900 nm.

3. The positive electrode of claim 1, wherein the non-metallic element comprises at least one element selected from the group consisting of Group 13 through 16 elements.

4. The positive electrode of claim 1, wherein the non-metallic element comprises at least one element selected from the group consisting of nitrogen (N), sulfur (S), phosphorus (P), selenium (Se), tellurium (Te), and boron (B).

5. The positive electrode of claim 1, wherein the carbonaceous material doped with the non-metallic element is a catalyst having conductivity, and the catalyst promotes an oxygen reduction reaction and an oxygen evolution reaction.

6. The positive electrode of claim 1, wherein the carbonaceous material doped with the non-metallic element further comprises an oxygen reduction catalyst and an oxygen evolution catalyst.

7. The positive electrode of claim 1, wherein the amount of the non-metallic element used to dope the carbonaceous material is in a range of about 0.1 to about 30 parts by weight based on 100 parts by weight of the carbonaceous material.

8. The positive electrode of claim 1, wherein the carbonaceous material doped with the non-metallic element further comprises a transition metal.

9. The positive electrode of claim 8, wherein the transition metal comprises at least one metal selected from the group consisting of cobalt (Co), nickel (Ni), iron (Fe), aurum (Au), silver (Ag), platinum (Pt), ruthenium (Ru), rhodium (Rh), osmium (Os), iridium (Ir), and palladium (Pd).

10. The positive electrode of claim 1, wherein the carbonaceous material doped with the non-metallic element further comprises a transition metal oxide selected from the group consisting of a manganese oxide, a cobalt oxide, an iron oxide, a zinc oxide, and a nickel oxide.

11. The positive electrode of claim 1, wherein the carbonaceous material comprises one material selected from the group consisting of carbon black, graphite, graphene, activated carbon, and carbon fiber.

12. A method of preparing a positive electrode for a lithium air battery, the method comprising:
(a) mixing a non-metal precursor and a mesoporous material with a solvent to prepare a slurry;
(b) drying the slurry and calcining the dried product under an inert atmosphere to produce a calcined product; and
(c) contacting the calcined product and a hydrogen halide.

13. The method of claim 12, wherein the non-metal precursor in operation (a) comprises at least one compound selected from the group consisting of quinoxaline, hemin, p-toluene sulfonic acid, cobalt-tetramethoxy-phenylporphyrin, iron-tetramethoxy-phenylporphyrin, phthalocyanine, cobalt-phthalocyanine, and iron-phthalocyanine.

14. The method of claim 12, wherein the slurry in operation (a) further comprises a transition metal precursor.

15. The method of claim 14, wherein the transition metal precursor comprises at least one compound selected from the group consisting of Fe(NO₃)₂, Fe(NO₃)₃, Fe(CH₃COO)₂ and Fe(CH₃COO)₃.

16. A lithium air battery comprising:
a negative electrode enabling intercalation and deintercalation of lithium ions;
an electrolyte; and
a positive electrode using oxygen as a positive electrode active material,
wherein the positive electrode further comprises a carbonaceous material doped with a non-metallic element.

17. The lithium air battery of claim 16, wherein the average particle diameter of the carbonaceous material doped with the non-metallic element is in a range of about 2 nm to about 900 nm.

18. The lithium air battery of claim 16, wherein the non-metallic element comprises at least one element selected from the group consisting of Group 13 through 16 elements.

19. The lithium air battery of claim 16, wherein the non-metallic element comprises at least one element selected from the group consisting of nitrogen (N), sulfur (S), phosphorus (P), selenium (Se), tellurium (Te), and boron (B).

20. The lithium air battery of claim 16, wherein the amount of the non-metallic element used to dope the carbonaceous material is in a range of about 0.1 to about 30 parts by weight based on 100 parts by weight of the carbonaceous material.

21. The lithium air battery of claim 16, wherein the carbonaceous material doped with the non-metallic element further comprises a transition metal.

22. The lithium air battery of claim 16, wherein the carbonaceous material doped with the non-metallic element further comprises a transition metal oxide.

23. The positive electrode of claim 1, wherein the specific surface area of the carbonaceous material doped with the non-metallic element may be measured by performing BET analysis and the analysis value of the specific surface area may be 10 m²/g or more.

24. The positive electrode of claim 1, wherein the amount of the carbonaceous material doped with the non-metallic element may be in a range of about 65 parts by weight to about 99 parts by weight of the positive electrode using oxygen as an active material.

25. The method of claim 12, wherein the mesoporous material is used as a template and the non-metal precursor is attached to the surface of the mesoporous material.

26. The method of claim 12, wherein the mesoporous material is mesoporous silica.
